(19) United States
(12) Patent Application Publication
(10) Pub. No.: US 2011/0125763 A1
(43) Pub. Date: May 26, 2011

(54) METHOD AND APPARATUS FOR DETERMINING SIMILARITY OF MEDIA INTEREST

(75) Inventors: Marko TAKANEN, Espoo (FI); Apaar TULI, Helsinki (FI)

(73) Assignee: Nokia Corporation, Espoo (FI)

(21) Appl. No.: 12/624,844

(22) Filed: Nov. 24, 2009

(51) Int. Cl. G06F 17/30

(52) U.S. Cl. 707/749; 707/E17.014

(57) ABSTRACT

An approach is provided for finding users with similar media interest. A media service platform retrieves a first media profile of a first user and a second media profile of a second user, wherein each of the profiles includes information of a plurality of media parameters and playback data relating to at least one of the plurality of media parameters. Next, the media service computes similarity values between the first user and the second user based on the weighted playback data of the media profiles. The media service platform then determines a similarity score between the first user and the second user using the similarity values.

### BACKGROUND

In the past, people generally have relied on social clubs, alumni networks, friends, co-workers, and other similar organizations and groups to meet new people with whom they want to develop relationship. With introduction of Internet and its ease of use, people started relying on the Internet to meet new people. However, even over the Internet, finding and meeting other people among complete strangers may raise some reservations or can even be intimidating. Thus, social networking methods have been used over the Internet to connect people. As more people rely on Internet social networking, it is desired to develop effective ways to connect people via the Internet social networking. Consequently, social networking service providers and manufacturers of devices operating over the social networks face considerable technical challenges to developing efficient mechanisms to enable users to discover people of similar interest.

### SOME EXAMPLE EMBODIMENTS

Therefore, there is a need for an approach for efficiently finding users with similar media interest (e.g. musical interest).

According to one embodiment, a method comprises retrieving a first media profile of a first user and a second media profile of a second user. Each of the profiles includes information of a plurality of media parameters and playback data relating to at least one of the plurality of media parameters. The method further comprises computing similarity values between the first user and the second user based on the weighted playback data of the media profiles. The method further comprises determining a similarity score between the first user and the second user using the similarity values.

According to another embodiment, an apparatus comprising at least one processor, and at least one memory including computer program code, the at least one memory and the computer program code configured to, with the at least one processor, cause, at least in part, the apparatus to retrieve a first media profile of a first user and a second media profile of a second user. Each of the profiles includes information of a plurality of media parameters and playback data relating to at least one of the plurality of media parameters. The apparatus is further caused to compute similarity values between the first user and the second user based on the weighted playback data of the media profiles. The apparatus is further caused to determine a similarity score between the first user and the second user using the similarity values.

According to another embodiment, a computer-readable storage medium carrying one or more sequences of one or more instructions which, when executed by one or more processors, cause, at least in part, an apparatus to retrieve a first media profile of a first user and a second media profile of a second user. Each of the profiles includes information of a plurality of media parameters and playback data relating to at least one of the plurality of media parameters. The apparatus is further caused to compute similarity values between the first user and the second user based on the weighted playback data of the media profiles. The apparatus is further caused to determine a similarity score between the first user and the second user using the similarity values.

According to another embodiment, an apparatus comprises means for retrieving a first media profile of a first user and a second media profile of a second user, wherein each of the profiles includes information of a plurality of media parameters and playback data relating to at least one of the plurality of media parameters. The apparatus further comprises means for computing similarity values between the first user and the second user based on the weighted playback data of the media profiles. The apparatus further comprises means for determining a similarity score between the first user and the second user using the similarity values.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of finding users with similar media interest, according to one embodiment;

FIG. 2 is a diagram of the components of media service platform, according to one embodiment;

FIG. 3 is a flowchart of a process for finding users with similar media interest, according to one embodiment;

FIG. 4 is a flowchart of a process for presenting visualization of users with similar media interest, according to one embodiment;

FIG. 5 is a flowchart of a process for finding users with similar media interest, according to one embodiment;

FIG. 6 is a plot showing an example of time-weighting values, based on a half-life equation, according to one embodiment;

FIG. 7 is a plot showing an example of time-weighting values, based on a half-life equation, according to one embodiment;

FIGS. 8A-8C are user interfaces of the media widget 111 of FIG. 1, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for finding users with similar media interest, such as musical interest, are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

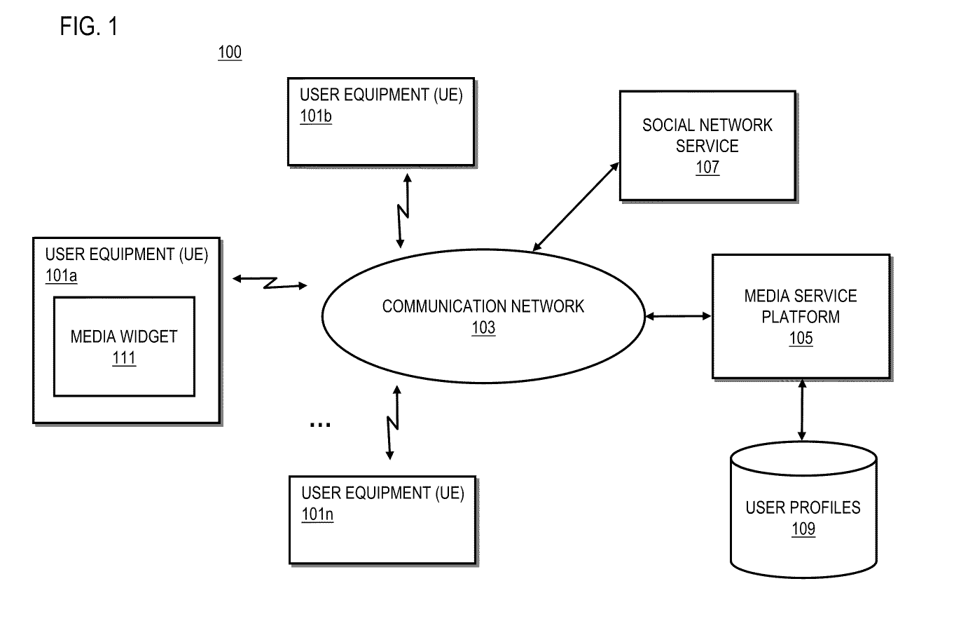

FIG. 1 is a diagram of a system capable of finding users with similar media interest, according to one embodiment. As discussed previously, a social networking service has emerged as a popular method to allow users to interact with one another and build a community of people over a network such as Internet. The social networking over the Internet is often based on the information provided by the users. For example, a user can set up a profile on the social network, which can include information about the user such as hobbies, favorite books, music and movies, schools attended, a current job, and etc. Then, other users on the social network are able to connect (e.g., create a relationship in a social network) with the user based on the information in the user profile. The user profile may also include a list of the user's friends on the social network, which can be viewed by other users on the network. The social network often allows users to create a group or a community that others on the same network can join. Thus, as people seek connections and relationships, the social networking can bring people together with similar interest or background.

Further, with the advancement in technology and ready-availability of various types of information, the world is changing fast and people also keep up with these fast changes. As a result, people also live very dynamic lives with constantly interests and activities. Therefore, the social networking methods need to be more interactive with the users to keep up with constantly-changing information about the users. In other words, the social networking methods have to become more interactive and responsive to meet user expectations. Thus, a successful social networking method in this should provide user information showing the user's interest and background as well as update such information based on the user's constantly changing activity or status. In this way, users to connect with other users more effectively.

Among the many interests that people have, interest in a variety of media (e.g, music, movies, electronic books, pictures, videos, games, radio and television channels, advertisements, media streaming, and etc,) can be a major hobby, especially in this era where users are constantly surrounded by media content via radio, television broadcasting or any other means. Even in an ordinary social setting, people often exchange their interest in music or movies as a part of their conversation in getting to know one another. For example, it is common for two people to decide to go see a live music by an artist after finding out that they both like the same artist. Further, people often try to create social groups so that people with similar taste in music or movies can gather together and share their interest. These social gatherings may be initiated by common interest in media at first, but can also provide useful means to develop wider range of social purposes other than the media-related interest. For example, people may join a musical interest group and initially meet people to pursue similar musical interest, and then they can become friends who may socialize in a different context other than musical interest. This is partly because music, movies, or other media can define various aspects of a person and thus can be used as a common interest that people can use to connect with one another.

For example, different types of music have different tunes or lyrics, and thus draw people with personalities or characteristics that prefer respective types of music. In addition, because music is created in various time periods and certain music defines those time periods (e.g. 70s disco, 80s music, teen pop of the late 90s and etc), the age group of the person who plays the music can be estimated. Further, because people's musical interest may change over time, monitoring the musical interest of a user may help estimate the user's most recent preferences, personalities or characteristics. In addition, movies or other media, just like music, have different themes, genres, etc. that appeal to almost any kind of taste or preference. Hence, the types of media a person favors can be used as an effective parameter to find other people with similar interest or background when used as a means for social networking. Over the Internet, a user may be able to find other people with similar taste in media, as a social networking means. Additionally, the user may discover new media by browsing the types of media preferred by other users with similar tastes.

Recently, more people are relying on digital media to render the media, such as listen to music watch movies or access other types of content, partly due to its easy accessibility via electronic devices and wide availability of computers and Internet. Digital media can also include useful information in its data, often as a metadata format. For example, digital music is often tagged with information such as an artist name, a music title, a genre of the music, and a release date of the music, and digital movies are often tagged with information such as a movie title, a director's name, names of actors and actresses, a genre of the movie, and a release date of the movie. The information also may include musical instruments involved in the media, a mood of the media, a number of beats per minute in the music and etc. This information has been conventionally used to inform users of the information on a song. For example, the artist's name, the song title and the genre can be extracted from the metadata and displayed on music playback software. Further, the media files can be organized by various parameters such as artists or genre using this information such that a user can browse media by artists or genres, or list media files by release dates, as shown in some media software. In addition, it is possible to keep a record of a user's playback history (e.g. how frequently the user played a certain media file), thus showing what type of media the user prefers to play based on the information about an artist, an author, a title, a genre of the media and etc., for example. Using this information, a method has been previously developed to automatically create a playlist of media files based on the user's playback, such as rendering and presentation, history of the medial files, in order to create a playlist of media files that the user prefers to play.

With the information available in digital media, media can be a powerful parameter in connecting people over the social network. Because the information within a digital media file may allow tracking a user's playback history, it is possible to keep the user's media interest updated, which may provide a more interactive and dynamic means to network with other users based on the media interest. However, in the past, media has not been extensively exploited as a means for networking among people over the Internet, mainly because digital media and its use with Internet have a relatively short history. Therefore, there is a need for an effective way to allow users to connect with one another based on their interest in media. Recently, there has been an attempt to use similarity in artists or media files played by users to compute similarity in media interest among users. Nevertheless, the conventional approach fails to consider various factors such as user's constantly-changing media interest and often compares similarity between only two users at a time. Thus, satisfying results in finding various users with similar media interest are not attainable via the current approach.

To address this problem, a system 100 of FIG. 1 introduces the following capabilities: (1) to obtain a playback history of each user and scale it based on time, (2) to compute similarities between one user and another user using the scaled playback history, and (3) to show users with similar media interest based on the computed similarities. More specifically, system 100 stores listening histories of users organized based on various parameters such as artist and genre, over a period of time, scales the playback history based on the time of the playback of media, and using the scaled playback history, and computes similarities in media interest between one user and other respective users. Accordingly, this approach allows a more accurate up-to-date presentation of users with similar taste in media because a properly-scaled playback history is used to compute the similarity score. In addition, this approach computes similarity scores of multiple users, and thus allows a user to see various users and their media taste in comparison with the user's media taste.

As shown in FIG. 1, the system 100 comprises a user equipment (UE) 101 having connectivity to a media service platform 105 and a social network service 107 via a communication network 105. For the sake of simplicity, FIG. 1 depicts only three UEs (e.g., UEs 101a, 101b-101n) in the system 100. However, it is contemplated that the system may support any number of UEs 101 up to the maximum capacity of the communication network 103. In one embodiment, the network capacity may be determined based on available bandwidth, available connection points, and/or the like.

By way of example, the communication network 103 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

The media service platform 105 may be used to provide media services to users over the communication network 103. The media service platform 105 may require the users to register with a media service to be able to access all services provided by the media service. The types of media services may include an on-line store that allows purchasing and downloading of media, sampling of media and purchasing tickets to events (e.g. tickets to concerts or theaters). The media services may also include media streaming service, quality ratings of songs or movies, reviews of songs or movies or artists or albums, popularity of each song or each movie, any news update from an artist and artists similar to a certain artist. Examples of providers of media services may include, but are not limited to, iTunes, Yahoo! Music Unlimited, RealNetwork's Rhapsody, Nokia's Comes with Music, Zune Social, and Last.fm (http://www.last.fm). The media service platform 105 may include applications for finding media files played by various users as well as applications for using the metadata tagged with media files to direct users to resources on the network where the user can sample, purchase or download those media files. The media service platform 105 may be interfaced with a database to store user information, metadata and event data. The database may include user profiles 109 that can be used to store user information such as user registration, a user name and a password, user's preferences and etc.

The media service platform 105 may also include applications that include algorithms to perform computations. These algorithms may be necessary when calculating a trend in media or any statistics in media, as well as computing any type of ratings such as popularity ratings of certain media. The media service platform 105 may defer these computations to UEs 101a-101n or the social network service 107, if desired. The media service platform 105 may also store results of the computations in a database such as the user profiles 109. Further, the media service platform 105 may use the results of the computations stored in the database to perform additional computations. For example, the media service platform 105 may keep a record of a user's playback history in a database such as the user profiles 109. The stored playback history can be used as useful information about the user's taste in media later.

The social networking service 107 allows users of the communication network 103 to communicate with one another. In more detail, the social networking service 107 allows the users to build communities of users over the communication network 103 who share the same interest or background or to explore other interests or activities through other users on the social network. As discussed previously, the type of media that is of interest to each user can be used as a means of social networking. Thus, in one embodiment, the social networking service 107 may also communicate with the UEs 101a-101n and the media service platform 105 to help the users of the social networking service 107 to connect with one another based on their musical interest. Further, although not shown in FIG. 1, the media service platform 105 may be embedded as a part of the social networking service 107.

The media widget 111 included in the UE 101b may be an software application that provides visualization (e.g. graphical user interface) to allow the user of UE 101b to perform tasks on the media widget 111. For example, the media widget 111 may include an option to display a list of media files in the UE 101b and may allow the user to organize the media files using the media widget 111. The media widget 111 may also include functions to create a playlist of media files or to reproduce a list of media based on a playlist. Thus, the media widget 111 may convey necessary information to the user and/or to allow the user to interact with the UE 101b. Further, the media widget 111 may include interfaces that allow the user to communicate with the media service platform 105. For example, the media widget 111 may include visual interfaces for tasks to be performed by the media service platform 105, such as purchasing music or movies, downloading media files and streaming media. The media widget 111 may also include visual interfaces to display any information from the media service platform 105, such as popularity ratings and news updates. In addition, the media widget 111 may also include interfaces to interact with the social network service 107.

By way of example, the UEs 101, the media service platform 105 and the social network service 107 communicate with each other and other components of the communication network 103 using well known, new or still developing protocols. In this context, a protocol includes a set of rules defining how the network nodes within the communication network 103 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

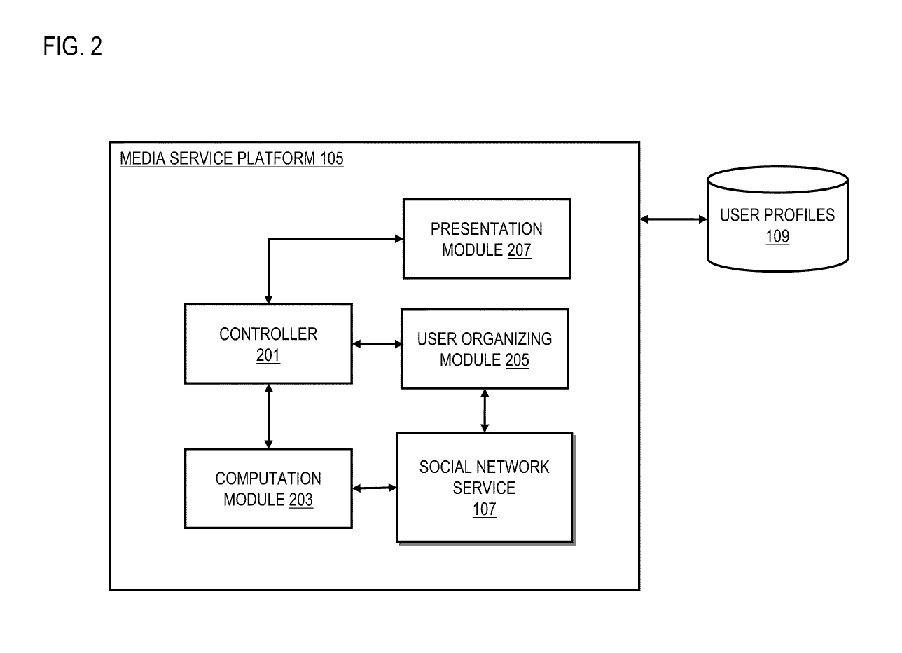

FIG. 2 is a diagram of the components of the media service platform 105, according to one embodiment. By way of example, the media service platform 105 includes one or more components for finding users with similar interest in media. It is contemplated that the functions of these components may be combined in one or more components or performed by other components of equivalent functionality. In this embodiment, the media service platform 105 includes a controller 201, a computation module 203, a user organizing module 203 and a presentation/rendering/playback module 207. The controller 201 oversees tasks, including tasks performed by the computation module 203, the user organizing module 205 and the presentation module 207. The computation module 203 performs various computations and estimations based on given information, including computations for finding user similarity (e.g., similarity of media interest). The user organizing module 205 organizes users based on various parameters, such as user's preferences for artist or genre. Further, the media service platform 105 may communicate with the social network service 107 to exchange information, for example, via the computation module 203 or the user organizing module 205. The presentation module 207 manages information and provides options to choose a presentation of the information in the media service platform 105, such that the information can be displayed on the media widget 111. The media service platform 105 may also be connected to a database such as user profiles 109, such that information from the media service platform 105 can be sent to the user profiles 109 to be stored in the user profiles 109 and that the media service platform 105 can access information stored in the user profiles 109.

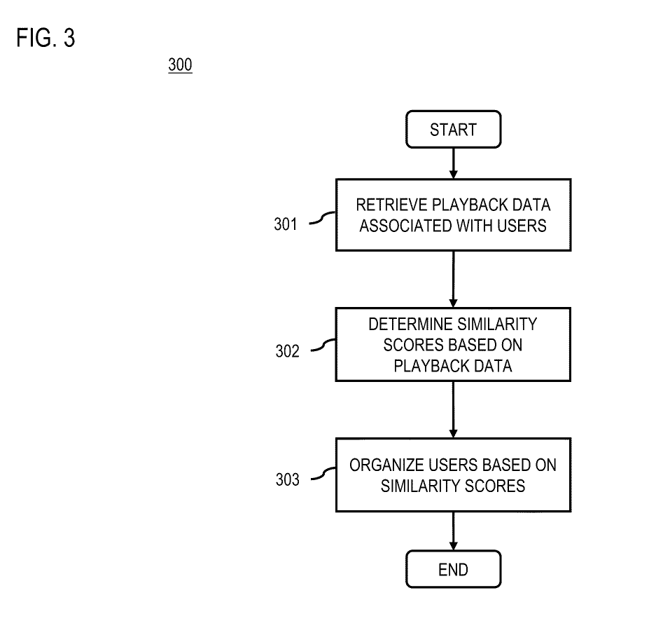

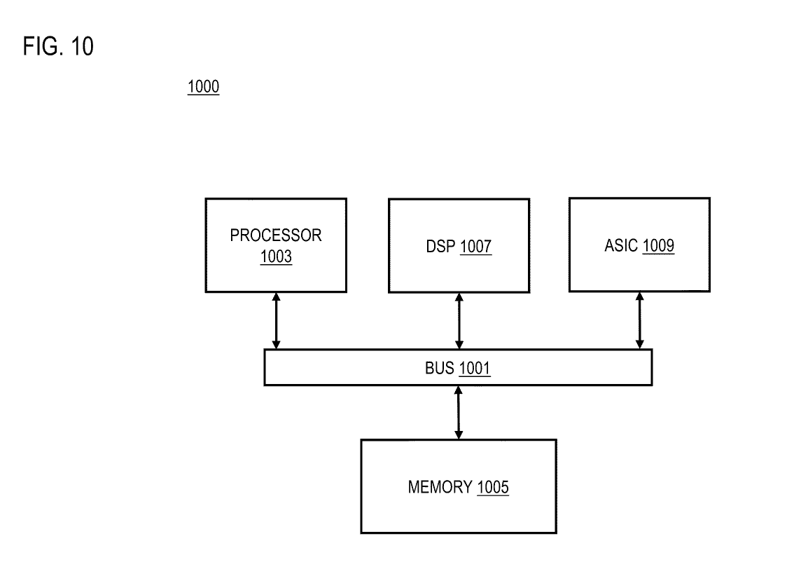

FIG. 3 is a flowchart of a process for finding users with similar media interest, according to one embodiment. In one embodiment, the media service platform 105 performs the process 300 and is implemented in, for instance, a chip set including a processor and a memory as shown FIG. 10. In step 301, the media service platform 105 receives the playback data associated with users (i.e. users of UEs 101a-101n) based on how frequently the users played the media. The media service platform 105 may acquire and organize the playback data by artists, genres as well as the time that the media is played. Thus, for example, there is a playback data for a song by a specific artist played by a specific user in a specific time period and there is a playback data for a song that belongs to a specific genre and played by a specific user in a specific time period. The media service platform 109 may store the playback data associated with the users in a database such as user profiles 109. In step 302, the media service platform 109 computes a similarity score for each user on the communication network 103 based on the playback data. In this step, the media service platform 109 may compute the similarity score from the playback data that is scaled based on the time that the media is played. In step 303, the media service platform 109 then organizes the users on the communication network 103 based on the similarity scores.

A user's playback history such as how frequently a user plays a certain media file (i.e. a playback data of a song) can be considered to determine similarities in media interest between users. For example, the media service platform 105 may keep a record of how frequently each media file is played for each user, thus producing a playback data associated with each user for each media file. As another example, the media service platform 105 keep a record of how frequently each artist is played by keeping a record of how frequently the media files including media by the corresponding artist are played by each user, thereby producing each user's playback data for each artist. The media service platform 105 may also record how frequently each genre is played, by keeping a record of how frequently the media files belonging to the corresponding genre are played by each user, thereby producing each user's playback data for each genre. Therefore, the playback data can be produced based on various parameters. The playback data with these various parameters can be stored in a database such as user profiles 109 to represent the user's playback history or the user's tendency in his/her media playing.

The media service platform 105 may compute similarity values for each user using the playback data scaled by the time-weighting. The similarity values may be calculated by a combination of the user's scaled playback data for various artists and the user's scaled playback data for various genres, and comparing the user's scaled playback data to another user's scaled playback data for the corresponding artists and the corresponding genres. Then, an overall similarity score can be computed based on the similarity values for each user on the communication network 103. In another embodiment, these computations may occur in the UE 101a or the social network service 107, instead of having the media service platform 105 perform the computation.

The similarities in media interest in relation with the users can be displayed on the media widget 111 included in the UE 101b. For example, the user that has the most similar taste in media (or the highest similarity score) to the user of the UE 101a will be placed on top of the list of the users displayed on the media widget 111. Further, the media widget 111 may include visualizations (e.g. graphical user interface) to convey necessary information to the user of the UE 101a and to allow the user of the UE 101a to interact with other UEs 101b-101n. In more detail, the media widget 111 may include visualization that shows a list of users within the communication network 103 (e.g. the users of UEs 101b-101n) with similar media interest to the user of the UE 101b, and may further include other options that the user of the UE101b can set to obtain the list of the users with similar media interest. Further, the social network service 107 can be used to introduce users with similar interest in media, based on the similarity scores. Then, the media widget 111 can communicate with the social network service 107 to connect the users and/or allow them to communicate with one another, by on-line chatting or messages, for example.

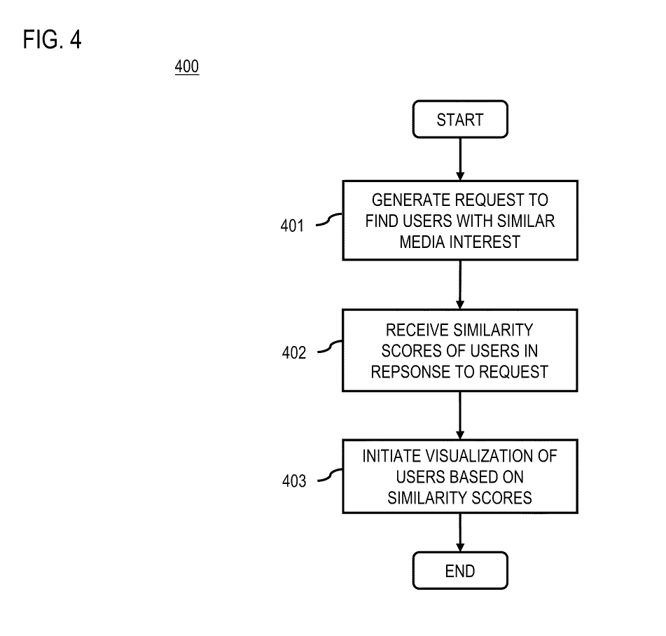

FIG. 4 is a flowchart of a process for presenting users with similar media interest, according to one embodiment. In one embodiment, a media widget 111 performs the process 400 and is implemented in, for instance, a chip set including a processor and a memory as shown FIG. 10. In step 401, the media widget 111 generates a request to find users with similar media interest. This request can be initiated manually by a user or can be automatically generated by the media widget 111. If the request is automatically generated, the request may be generated periodically to constantly update the user similarity in media interest. This request may be sent over the communication network 103 to the media service platform 105 or the social network service 107, if the media service platform 105 or the social network service 107 has necessary information to find users with similar taste in media. Alternatively, if the media widget 111 already has necessary information to find users with similar taste in media, then the request may be made internally within the user equipment. Then, a similarity score of each user illustrating how similar each user is to the user of the user equipment is computed. The similarity scores can be computed in the media service platform 105 or the social network service 107. Alternatively, the similarity scores can be computed by the media widget 111. Generally, computation of the similarity of score can be an intensive process because it involves many users and multiple parameters. Thus, it may be more desirable to compute the similarity scores in the media service platform 105 or the social network service 107, which tends to have more available processing power and resources than the media widget 111. The computed similarity scores of the users are then received by the media widget 111. The users may be ranked based on the similarity scores, with the user with the highest similarity score listed at the top and the user with the lowest similarity score listed on the bottom. As shown in step 403, visualization can be initiated to show a list of users that are listed based on the similarity scores.

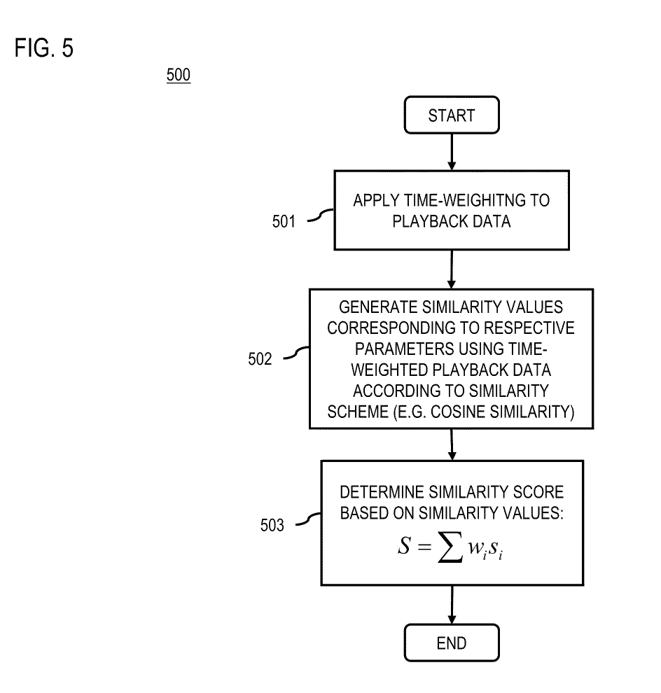

FIG. 5 is a flowchart of a process for computing a similarity score between users, according to one embodiment. In one embodiment, the media service platform 105 or the social network service 107 performs the process 500 and is implemented in, for instance, a chip set including a processor and a memory as shown FIG. 10. In step 501, playback data is scaled based on the time that media is played (i.e. time-weighted). Step 501 is generally performed by the media service platform 105, and the scaled playback data is stored in a database such as the user profiles 109. In step 502, the scaled (i.e. time-weighted) playback data for a corresponding user is used to generate similarity values between the user of the user equipment and the corresponding user according to a similarity scheme wherein similarity values are generated according to their respective parameters. The similarity scheme can be based on a mathematical equation such as cosine similarity, which is used to measure similarity between two vectors. In Step 503, a similarity score between the user of the user equipment and the corresponding user is determined based on the similarity values between the user of the user equipment and the corresponding user. As shown in step 503, the similarity score may be calculated by summing weighted similarity values.

As one example, the similarity in media interest between users may be determined by considering the playcount categorized by each media parameter, as a playback data. For example, with respect to a music service, if artist is used as a parameter for the playback data, the fact that user A who listens to Artist I twenty times a day would be an indication that user A's taste in music is similar to the taste of user B who listens to Artist I eighteen times a day, but is not very similar to the musical taste of user C who listens to Artist I five times a day. Depending on a media parameter or a type of media, it may be desirable to consider multiple media parameters. For example, because there are a vast number of artists and songs and users listen many different artists, many users may not listen to the same artists in common. Hence, comparing the playcount of numerous artists or songs may result in very little similarity among users. In addition to this approach, other parameters such as a playcount of each genre can also be considered. For example, if user A listens to Artist I twenty times a day and Artist I belongs to the Rock genre, user A may be considered to have a similar musical interest as user B who listens to Artist V seventeen times, wherein Artist V belongs to the Rock genre. The playcount data based on the genres can be used alone or in combination with the playcount data based on the artists, in order to determine the similarity in musical interest.

As shown in step 501, the playback data may need to be weighted according to time the playback data is acquired (time-weighting). People's preferences are likely to change over time partly because people constantly experience changes in various aspects of their lives. For example, because a person's preferences may be different today than five days ago, different considerations may need to be given to the person's preference five months ago than to the person's preference today in order to determine the person's most recent preference. It may be beneficial to apply more weight to the more recent preference because the more recent preference tends to be more relevant to the person's current preference than the less recent preference. Accordingly, playback data acquired more recently may be a better reflection of the user's taste in media than playback data acquired some time ago, and thus more weight may need to be given to the more recent playback data. For example, more weight can be given to the media files that were played more recently (e.g. one day ago) and a less weight can be given to the media files that were played earlier (e.g. six months ago).

In one embodiment, the playback data can be scaled such that more recent playback data is multiplied by a greater number than the less recent playback data. Time-weighting of the playback data can be applied in a predetermined time increment (e.g. by hour or by day or by week). For example, if the playback data is time-weighted by day, then the playback data collected yesterday will be given a certain weight, and the playback data collected today will be given another weight greater than the weight given to the yesterday's playback data. Furthermore, the time-weighting of the playback can be performed by updating the value of the past playback data by scaling with a time-weight. For example, the playback data stored in the user profiles can be brought up to date by applying an appropriate time-weight. One way to apply the time-weight is by multiplying the playback by the time-weight corresponding to the number of days passed since the last update of the time-weighting had occurred. For the playback that had occurred after the previous update, an appropriate time-weighting can be applied by a desired time increment, and then this playback can be added to the previously-stored playback that is appropriately time-weighted.

The value for the time-weighting can be defined by a mathematical equation that produces a lesser value for more time. The purpose is to scale the playback data so that an older playback data would be scaled with a lesser value. A half-life equation may be used to scale the playback data based on an exponential function. For example, the relevancy factor (the time-weighting factor) of the playback data can be determined based on the following equation:

$$r = {2}^{- \frac{a - {T}_{0}}{{T}_{1 / 2}}} \qquad ( 1 )$$

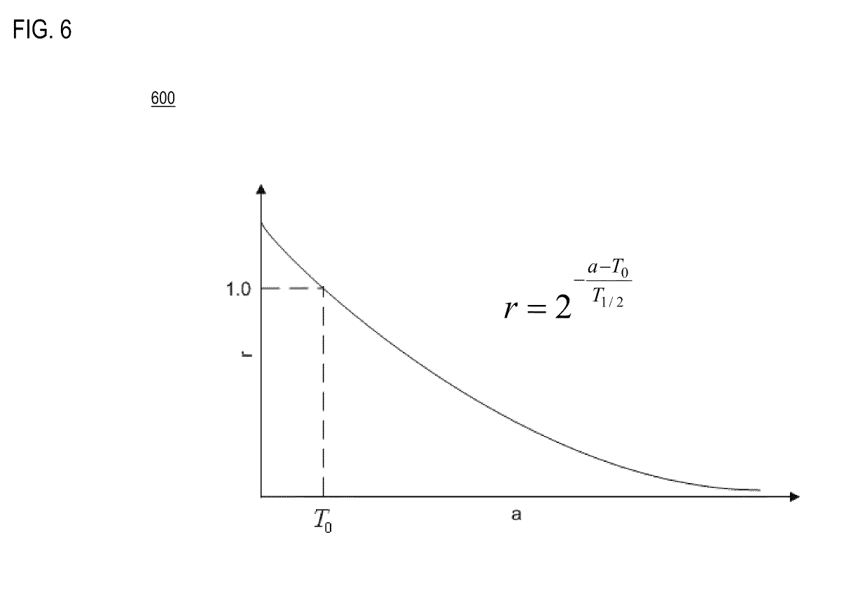

, wherein r=relevancy factor (time-weighting factor) of the playback data, a=age (time) of listening in a predetermined increment (day, week, month), T_{1/2}=half-life of the relevancy factor (i.e., the time required for the relevancy factor to decay to half of its initial value), Tₒ=offset factor to make the relevancy factor of the last listen equal to one. FIG. 6 illustrates an example graph of a half-life equation, according to one embodiment. As shown in FIG. 6, the older the playback is (greater a value), the less relevancy factor will be produced by this equation.

The time-weighted playback data may then be used to compute the similarity in media interest. In an example of music, if the users only listen to music by very few artists, it may not be difficult to manually compare the playback data of the users to determine the similarity in musical interest. However, because users generally listen to music by many different artists and genres, it is desired to apply a mathematical algorithm to the playback data to determine the similarity of musical interest. The similarity in media interest among two users may be determined using a mathematical measure called cosine similarity. The cosine similarity measures similarity of two vectors of n dimensions, and can be defined as the following equation:

$$s = cos ( θ ) = \frac{A \cdot B}{\vert A \vert \vert B \vert} = \frac{{\sum }_{i = 1}^{n} {a}_{i} {b}_{i}}{{\sum }_{i = 1}^{n} {a}_{i}^{2} {\sum }_{i = 1}^{n} {b}_{i}^{2}} \qquad ( 2 )$$

wherein s is a similarity value between users, and A and B are vectors of n dimensions. The similarity according to the equation (1) ranges from −1 to 1, wherein −1 means A and B are exactly opposite, 0 means A and B are independent from each other, and 1 means A and B are exactly the same. However, because there is no negative value in playback data, the value of similarity according to an embodiment of the invention ranges from 0 to 1.

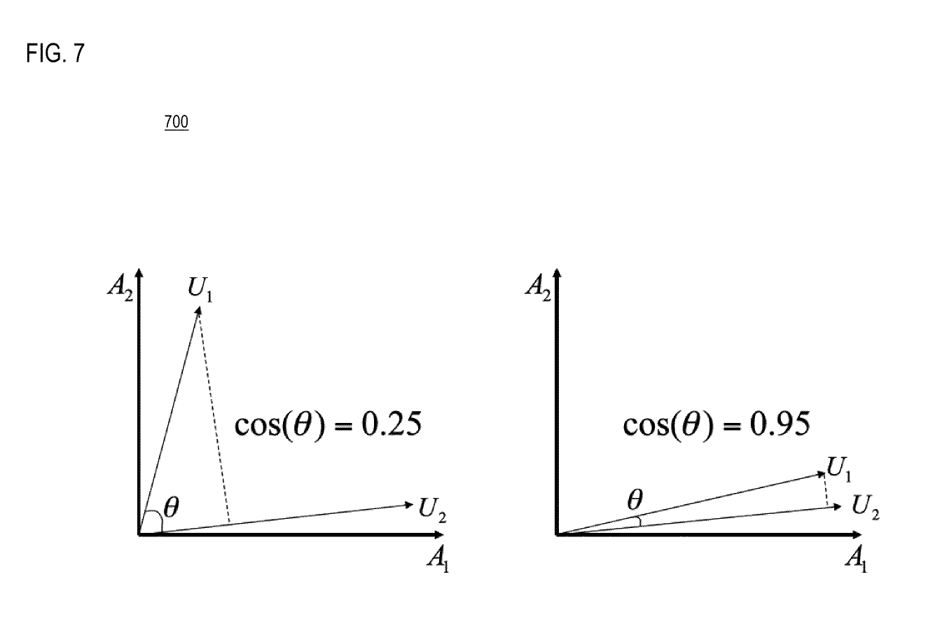

FIG. 7 illustrates examples of comparing two users' media interest by comparing their frequencies of playback for two artists (thus, analyzing two dimensional vectors). In FIG. 7, if two vectors U₁ and U₂ representing two users' frequencies of playback of two artists A₁ and A₂ (i.e. two dimensional vectors) to determine the similarity in media interest between them, two vectors being more parallel means that the two users have more similar media interest. As shown on the left-hand graph of FIG. 7, user 1 whose media tendency is represented by U₁ plays media by artist A₂ much more than artist A₁, and user 2 whose media tendency is represented by U₂ plays media by artist A₁ much more than artist A₂. Then, the cosine value of these two vectors will produce little similarity (i.e. close to 0). As another example shown on the right-hand graph of FIG. 7, if both user 1 and user 2 play media by artist A₁ much more than artist A₂, then vectors U₁ and U₂ are more parallel to one another and thus the cosine value of these two vectors will produce greater similarity (i.e. close to 1.0). Similarly, although not shown in FIG. 7, genres of the media that the users play can be analyzed. In an example of music, if user 1 listens to music by artist A₂ which belongs to the Rock genre much more than music by artist A₁ which belongs to the Jazz genre, and user 2 listens to artist A₁ much more than artist A₂, then the cosine similarity equation will produce little similarity.

The examples shown in FIG. 7 are rather simple examples involving only two artists. However, as explained above, a practical implementation of this method will involve many different artists, and thus the users may not play media by the same artists. Therefore, various other parameters such as genres may be used in determining the similarity in media interest, by generating multiple similarity values corresponding to respective parameters, as shown in step 502. Then, as shown in step 503, after multiple similarity values are created according to multiple different parameters, each similarity value may be given a different weight in order to compute an overall similarity score. For example, if the similarity value calculated based on parameter A (e.g. artists) is considered more important than the similarity value calculated based on parameter B (e.g. genres), then more weight can be given to the similarity value based on parameter A. When computing an overall similarity score based on multiple parameters, similarity values may be weighted based on the corresponding parameters and summed to produce the overall similarity score. The weight may be distributed such that the similarity score would range from 0 (no similarity) to 1 (maximum similarity).

$$S = {\sum }_{i = 1}^{n} {w}_{i} {s}_{i} , wherein {\sum }_{i = 1}^{n} {w}_{i} = 1 \qquad ( 3 )$$

For example, if S is determined based on two parameters (i.e. n=2), artists and genres, and the similarity value based on the genres, s₁, is considered four times as important as the similarity value based on the artists, s₂, then w₁ can be set as 0.8 and w₂ can be set as 0.2, such that the sum of the similarity values ranges from 0 to 1. The similarity scores then may be sorted in a descending order such that the media widget 111 can display them with respect to the users.

In some embodiments, the approach described herein may be used to compare how other external factors (e.g., advertising, peer recommendations, etc.) may influence a user's choice or interest in specific media (e.g., the advertised or recommended media). In this scenario, the similarity score is computed between the same user but at different periods of time rather than between different users. In this way, any changes in the media interest of the user can be measured. For example, the interest of the user at a time before the start of an advertising campaign can be measured against the user's media interest at a time after the end of the advertising campaign. The similarity score between the two times may then be used as one way to measure the effect the effect of the campaign on the user. In another embodiment, the similarity score can be computed at multiple time periods or frequencies (e.g., every two days, every two weeks, etc. for a period of time after the advertisement or other event) to measure the user's interest develops or changes over time. This sequence of similarity scores can show, for instance, how long it took for an advertisement to affect the user, how long the effect lasted, etc.

Further, any other information that is useful to a user may be estimated, in order to be displayed on the media widget 111. As discussed previously, the parameters may include a title, an artist, a genre, a sub-genre, names of actor and actresses, an author, beats per minute (bpm), and thus similarity scores based on one or more of these parameters may be calculated. The names of the common parameters (e.g. names of common artist, common genres and etc.) between the users may also be saved to be displayed by the media widget 111. Further, top common parameters may be estimated based on the playback data. For example, top three common artists and top three common genres can be estimated based on the playback data and the names of the top three artists and the top three genres can be saved to be displayed by the media widget 111. In addition, similarities may be displayed among different types of media. For example, based on the similarities in interest in music, similarities in interest in movies may be estimated. Also, as an example, if an artist for a song is a common artist, then movies including the artist's song may be listed.

When a computation is performed to rank the user similarity, the computation is likely to be complicated to cause the complexity of O(n²) problem, wherein n is the number of users in the service. Therefore, this computation of user similarity becomes very computationally intensive, consuming a lot of time as well as storage space. It is not desirable to process the entire computation on-demand from scratch because this computation is very time-consuming. In addition, it is not also desirable to store the entire pre-computed similarity scores in a database because much storage space is needed to store all the information related to the user similarity. These problems of time and storage space may be balanced by pre-computing some of the process and storing them in a database, and then perform the rest of the computation on-demand from the stored data. For example, the playback data may be computed and possibly time-weighted, and then stored in a database, such that the similarity scores may be calculated based on the stored playback data later when the similarity scores are demanded. As previously discussed, the playback data may be collected in time increment, and may be time-weighted, before being stored in the database.

In one embodiment, the media service platform 105 and/or the social network service 107 may compute, request, or otherwise receive the user similarity scores between two or more users to determine whether to establish a relationship between the users in the social network service 107. By way of example, if the score is above a predetermined threshold of similarity, the media service platform 105 or the social network service 107 can suggest a potential relationship to the users. In another embodiment, the media service platform 105 may create the relationship automatically if the similarity score is above another or the same threshold.

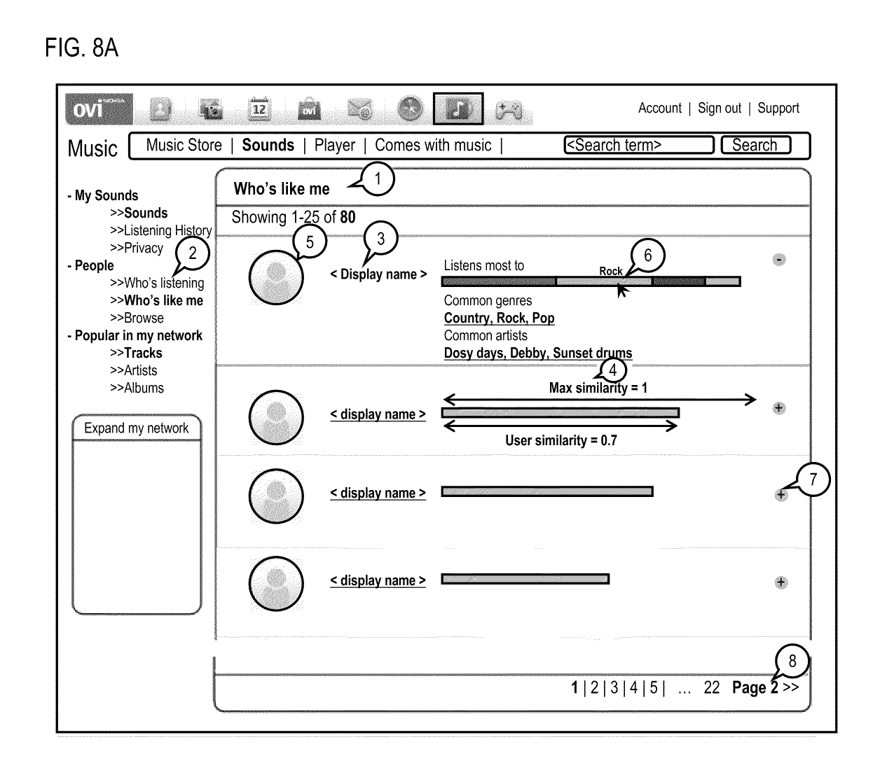

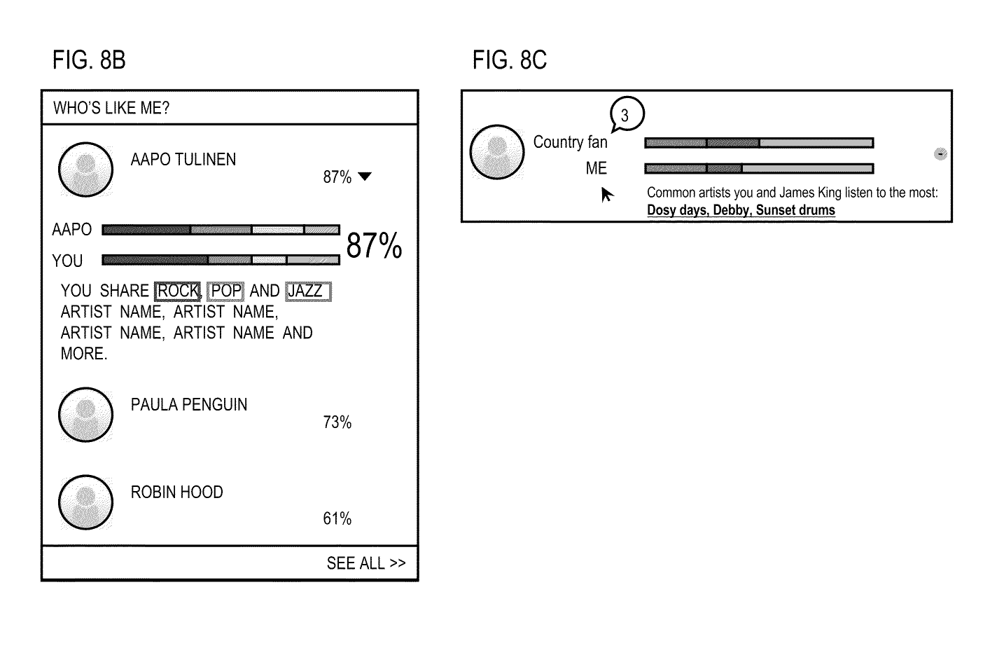

FIGS. 8A-8C are examples of user interfaces by the media widget 111 to display similarity scores of each user, according to various embodiments. In this specific example shown in FIGS. 8A-8C, a user interface for music is shown. If the equation (3) returns a similarity score ranging from 0 to 1, this can be presented on a user interface in various ways. The user interface may include options that a user can choose, and the options may allow the user to connect with other users. For example, as shown in FIG. 8A, arrow 2 shows that the left column may include options under “People” that allow the user to find out “Who's listening” and “Who's like me.” If the user chooses the “Who's like me” option, then the user interface shown in FIG. 8A under arrow 1 “Who's like me” appears on the right-hand column. The “Who's like me” column may include a list of users (e.g. arrow 5) with their similarity scores showing how they are similar to the user of the user interface. For each user on the list, the name of the user is displayed (arrow 3), as well as a bar (arrow 4) representing the similarity score ranging from 0 to 1. If the similarity score is too low to be displayed as a bar (e.g. 0.0001), then a minimum length of the bar may be set to be displayed for the similarity scores that are too low to be displayed. Alternatively, the media widget 111 could be set so that only the users that satisfy certain conditions are displayed on the media widget. For example, only users with the similarity score of a certain range (e.g. similarity score of higher than 0.01 or a similarity score ranging from 0.5-0.8) can be set to be displayed on the media widget 111. As another example, only top 50% of users based on the similarity score can be set to be displayed.

Further, the information on the similarity may be displayed in a simple version with only a bar representing the similarity score, wherein the length of the bar corresponds to the similarity score. The user may also click on the plus sign (arrow 7) to expand the window for more details on the similarity. If the user clicks on the plus sign, the plus sign may turn into a minus sign as the window expands to show more details on the similarity. For example, on the expanded window, the bar representing the similarity may be divided in different colors or divided into different sections, each color or each section showing the proportions of the user's musical interest depending on genres, based on the user's listening history (arrow 6). Thus, as one example, if the user has listened to a total of one hundred tracks, out of which twenty tracks were rock songs and eighty tracks were pop songs, then the bar on the expanded window may have 20% red to represent rock songs and 80% pink to represent pop songs. Further, if the cursor is brought to the “Rock” genre portion of the bar, then the word “Rock” may appear (arrow 6), but the word “Rock” may disappear if the cursor is brought away from the “Rock” genre portion of the bar. The expanded window may include names of the common genre and names of the common artists. In this example, top three most common genres and top three most common artists are displayed. However, the number of top most common genres and the number of top most common artists to be displayed may be customizable by a user or a system administrator. Further, the bottom of the user interface may include pagination with a clickable option to show the next list of the users (e.g. arrow 8).

FIG. 8B shows the user interface according to another embodiment. In this embodiment, the percentage of similarity may be displayed, wherein 100% means maximum similarity and 0% means no similarity. This embodiment may display a limited number of users, with a clickable option “see all” to see all of the users and their percentages of similarity. Also, FIG. 8C shows another embodiment, wherein a bar representing the user's preference in music based on genres (“ME”) is displayed next to another bar representing another user's preference in music based on genres (“Country fan”). The genres may be mapped in specific colors to provide visual comparison.

The processes described herein for finding users with similar musical interest may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

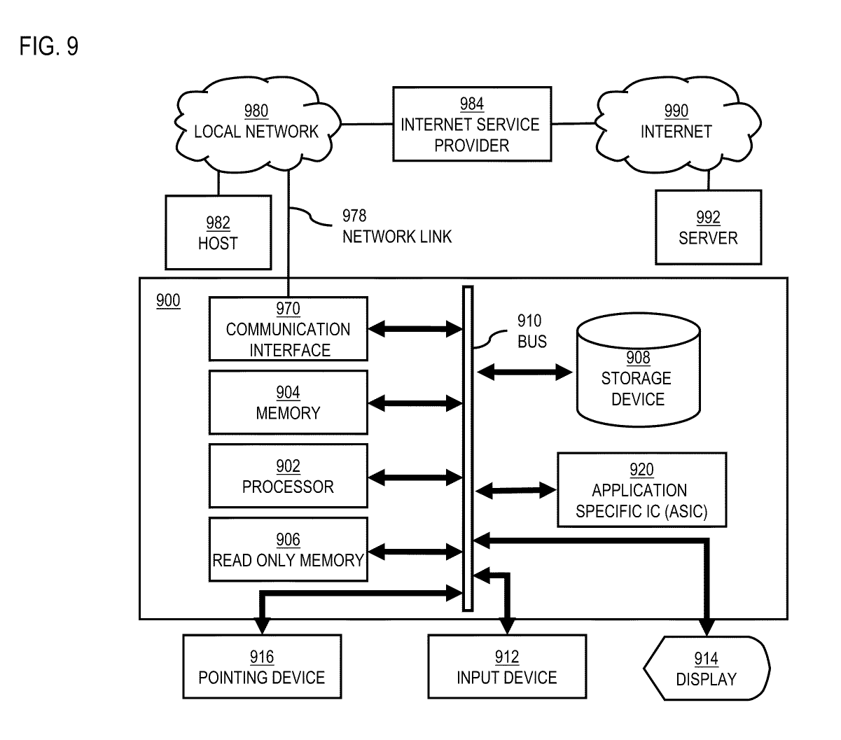

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to find users with similar musical interest as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of finding users with similar musical interest.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to find users with similar musical interest. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for finding users with similar musical interest. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for finding users with similar musical interest, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for finding users with similar musical interest.

The term “computer-readable medium” as used herein to refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to find users with similar musical interest as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of finding users with similar musical interest.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to find users with similar musical interest finding users with similar musical interest. The memory 1005 also stores the data associated with or generated by the execution of the inventive steps.

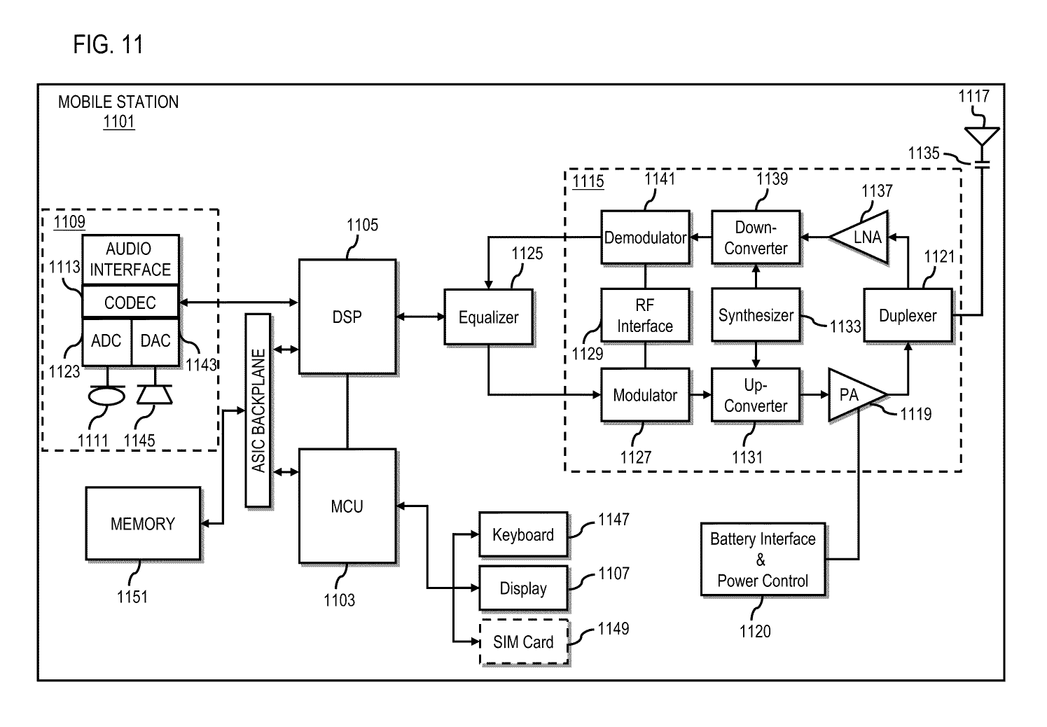

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of finding users with similar musical interest. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of finding users with similar musical interest. The display 11 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to find users with similar musical interest. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
retrieving a first media profile of a first user and a second media profile of a second user, wherein each of the profiles includes information of a plurality of media parameters and playback data relating to at least one of the plurality of media parameters;
computing similarity values between the first user and the second user based on the playback data of the media profiles; and
determining a similarity score between the first user and the second user using the similarity values.

2. A method of claim 1, further comprising:
weighting the playback data based on time,
wherein the similarity values are computed based on the weighted playback data.

3. A method of claim 2, wherein the weighting includes:
updating the playback data by weighting the playback data with an amount of time passed since a previous update; and
adding the updated playback data to a currently-acquired playback data.

4. A method of claim 1, wherein the weighting includes multiplying the playback data by a relevance factor, the relevance factor being greater for more recent playback data.

5. A method of claim 1, wherein the plurality of media parameters includes at least one of titles, artists, genres, musical instruments, actors, actresses, authors, a mood of media and a number of beats.

6. A method of claim 1, wherein the each of the similarity values is computed using a cosine similarity method on a first vector corresponding to the first user and a second vector corresponding to the second user, each of the first and second vectors being defined by the weighted playback.

7. A method of claim 1, wherein determining the similarity score includes:
weighting the similarity values by multiplying each similarity value by a respective score weight; and
summing the weighted similarity values to determine the similarity score.

8. A method of claim 1, further comprising:
determining whether to establish a relationship between the first user and the second user in a social networking service based on the similarity score; and
causing, at least in part, establishment of the relationship based on the determination.

9. An apparatus comprising:
at least one processor; and
at least one memory including computer program code,
the at least one memory and the computer program code configured to, with the at least one processor, cause the apparatus to perform at least the following,
retrieve a first media profile of a first user and a second media profile of a second user, wherein each of the profiles includes information of a plurality of media parameters and playback data relating to at least one of the plurality of media parameters,
compute similarity values between the first user and the second user based on the weighted playback data of the media profiles, and
determine a similarity score between the first user and the second user using the similarity values.

10. An apparatus of claim 9, wherein the apparatus is further caused to:
weight the playback data based on time,
wherein the similarity values are computed based on the weighted playback data.

11. An apparatus of claim 10, wherein weighting of the playback data includes causing the apparatus to:
update the playback data by weighting the playback data with an amount of time passed since a previous update; and
add the updated playback data to a currently-acquired playback data.

12. An apparatus of claim 9, wherein weighting of the playback data includes causing the apparatus to:
multiply the playback data by a relevance factor, the relevance factor being greater for more recent playback data.

13. An apparatus of claim 9, wherein the plurality of media parameters includes at least one of titles, artists, genres, musical instruments, actors, actresses, authors, a mood of media and a number of beats.

14. An apparatus of claim 9, wherein the each of the similarity values is computed using a cosine similarity method on a first vector corresponding to the first user and a second vector corresponding to the second user, each of the first and second vectors being defined by the weighted playback data.

15. An apparatus of claim 9, wherein determining the similarity score includes causing the apparatus to:
weight the similarity values by multiplying each similarity value by a respective score weight; and
sum the weighted similarity values to determine the similarity score.

16. An apparatus of claim 9, wherein the apparatus is further caused to:
determine whether to establish a relationship between the first user and the second user in a social networking service based on the similarity score; and
cause, at least in part, establishment of the relationship based on the determination.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
retrieving a first media profile of a first user and a second media profile of a second user, wherein each of the profiles includes information of a plurality of media parameters and playback data relating to at least one of the plurality of media parameters;
computing similarity values between the first user and the second user based on the weighted playback data of the media profiles; and
determining a similarity score between the first user and the second user using the similarity values.

19. A computer-readable storage medium of claim 6, wherein the apparatus is further caused to perform:
weighting the playback data based on time,
wherein the similarity values are computed based on the weighted playback data.

20. A computer-readable storage medium of claim 6, wherein determining the similarity score includes causing the apparatus to perform:
weighting the similarity values by multiplying each similarity value by a respective score weight; and
summing the weighted similarity values to determine the similarity score.
